(19) United States
(12) Patent Application Publication
(10) Pub. No.: US 2012/0029717 A1
(43) Pub. Date: Feb. 2, 2012

(54) RECONFIGURABLE LOAD-CONTROL RECEIVER

(76) Inventors: Robert J. Cox, Maple Grove, MN (US); Ryan F. Brager, Maple Grove, MN (US); James A. Coffel, Shakopee, MN (US); Nathan A. Brandt, Maple Grove, MN (US)

(21) Appl. No.: 12/845,506

(22) Filed: Jul. 28, 2010

(51) Int. Cl. G06F 1/26; H01H 9/54

(52) U.S. Cl. 700/295; 307/140

(57) ABSTRACT

A reconfigurable load-control receiver for communication with a first long-haul network and selectively adaptable to be reconfigured and in communication with a second long-haul network, a short-haul network and an electrical load. The reconfigurable load-control receiver includes a switching device adapted to control power to the electrical load, and a controller coupled to the switching device and adapted to switch between operating as a gateway and operating as a node.

### FIELD OF THE INVENTION

The present invention relates generally to controlling loads selectively connected to a utility source. More particularly, the present invention relates to self-configuration of communicative load-control devices.

### BACKGROUND OF THE INVENTION

To manage electricity usage during times of peak demand, utility companies traditionally enroll consumers in load management, or load-shedding programs. Participants of load-management programs agree to allow utility companies to reduce their power consumption by controlling operation of high-energy usage loads, typically appliances such as air conditioners, hot water heaters, pool heaters and so on. Control of such loads may be accomplished through the use of a communicative controller cooperating with a device, such as a relay, that interrupts power to the load based on commands broadcast from the utility company.

Such traditional “top-down” approaches to controlling energy usage rely on the utility to manage nearly all aspects of an energy management program, including supplying the equipment, determining which loads to control, when to control the loads, and for how long. Alternatively, in the newer, “bottom-up” approach encouraged by the expansion of advanced metering infrastructure (AMI), “smart grid” and other such electricity networking technology, control over energy usage has shifted downwards to the individual energy consumers. Advanced meters, energy-saving appliances, programmable thermostats, and other such devices located at a given facility communicate with each other over short distances via a short-haul network and with the utility company over relatively-long distances via a long-haul network. As such, technologically advanced bottom-up approach to controlling energy consuming devices by individual energy consumers distributes the decision-making and authority for managing local energy usage to each of the individual energy consumers.

Consequently, known energy-management solutions tend to be directed to either the earlier top-down approach, or the later, bottom-up approach. Similarly, systems, devices, and methods of executing such solutions are designed to operate within either the utility-centric, top-down approach, or the consumer-centric, bottom-up approach, but not within both approaches.

### SUMMARY OF THE INVENTION

Embodiments of the present invention provide energy-management solutions compatible with both the earlier, top-down approach and the newer, bottom-up approach.

In one embodiment, the invention comprises a method of operating a reconfigurable load-control receiver in initial communication with a first long-haul network and selectively adaptable to be reconfigured and in communication with a second long-haul network and to a short-haul network associated with a facility that includes the reconfigurable load-control receiver and an electrical load controlled by the reconfigurable load-control receiver. The method includes operating a reconfigurable load-control receiver as a gateway for the first long-haul network to administer a short-haul network associated with the facility that includes the load-control receiver and an electrical load controlled by the reconfigurable load-control receiver, the load-control receiver controlling power delivered to the load in response to a load-control message received over the first long-haul network.

The method also includes receiving at the reconfigurable load-control receiver a first role-change configuration message transmitted over the first long-haul network, and in response to the first role-change configuration message, reconfiguring the reconfigurable load-control receiver to stop operating as the gateway and start operating as a node in a short-haul network such that another device in the short-haul network serves as a gateway to the second long-haul network, and wherein when the load-control receiver operating as a node controls power delivered to the load in response to a load-control message received over the second long-haul network and the short-haul network.

In another embodiment, the present invention comprises a reconfigurable load-control receiver for initial communication with a first long-haul network and selectively adaptable to be reconfigured and in communication with a second long-haul network and to a short-haul network associated with a facility that includes the reconfigurable load-control receiver and an electrical load controlled by the reconfigurable load-control receiver. The reconfigurable load-control receiver includes: means for initially operating as a gateway connecting a short-haul network associated with a facility to a first long-haul network; means for operating as a node in a short-haul network while another device in the short-haul network serves as a gateway to connect the short-haul network to a second long-haul network; means for switching between operating as the gateway connecting the short-haul network associated with the facility to the first long-haul network and operating as a node in the short-haul network while another device in the short-haul network serves as a gateway to connect the short-haul network to the second long-haul network; and means for controlling power delivered to the load in response to a load-control message received over the first long-haul network or the second long-haul network and the short-haul network.

In yet another embodiment, the present invention comprises a reconfigurable load-control receiver for initial communication with a first long-haul network and selectively adaptable to be reconfigured and in communication with a second long-haul network, a short-haul network associated with a facility that includes the reconfigurable load-control receiver and an electrical load controlled by the reconfigurable load-control receiver. The reconfigurable load-control receiver includes a switching device adapted to control power to an electrical load at a facility and a controller communicatively coupled to the switching device and adapted to switch between operating as a gateway connecting a short-haul network associated a facility to a first long-haul network, and operating as a node in the short-haul network.

The controller includes a long-haul transceiver adapted to receive load-control messages over the first long-haul network; a short-haul transceiver adapted to receive and transmit messages over a short-haul network associated with the facility; and a processor communicatively coupled to the long-haul transceiver and the short-haul transceiver, the processor adapted to control the switching device in response to load-control messages received over the first long-haul network while the controller is configured as the gateway and to control the switching device in response to load-control messages received over the short-haul network and a second long-haul network while the controller is configured to operate as a node of the short-haul network.

### BRIEF DESCRIPTION OF THE DRAWINGS

The invention may be more completely understood in consideration of the following detailed description of various embodiments of the invention in connection with the accompanying drawings, in which:

FIG. 1 is an illustration of a load-control system having a load-control receiver communicating over a long-haul network with a utility;

FIG. 2 is an illustration of a load-control system having a meter communicating with over a long-haul network with a utility and communicating over a local network to a load-control receiver and a plurality of local devices;

FIG. 3 is an illustration of a load-control system having a reconfigurable load-control receiver configured to serve a gateway communicating over a long-haul network with a utility and with local devices over a short-haul network, according to an embodiment of the present invention;

FIG. 4 is an illustration of the load-control system of FIG. 3, the reconfigurable load-control receiver configured to act as a node in a short-haul network, rather than a gateway;

FIG. 5 is a flowchart of the load control receiver of FIGS. 3 and 4 configured and operating as a gateway; and

FIG. 6 is a flowchart of the load control receiver of FIGS. 3 and 4 configured and operating as a node.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

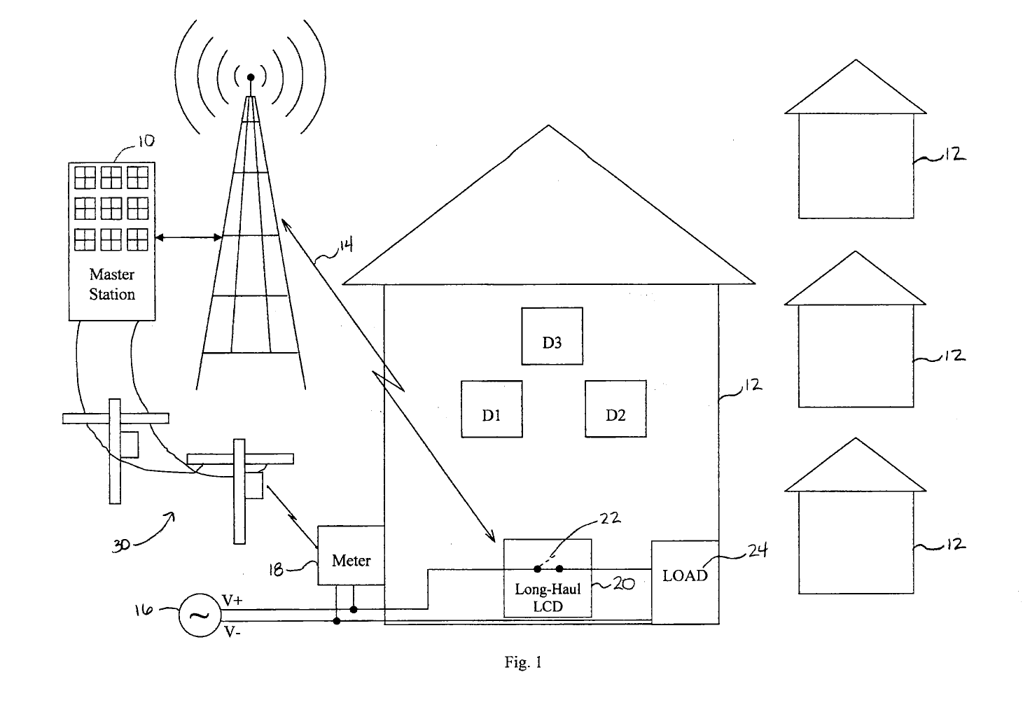

A system for controlling a load is depicted in FIG. 1. In such a system, a master station 10 of a utility communicates with multiple facilities or buildings 12 over long-haul communications networks 14 and 30. Facility 12, subject to load control by master station 10, typically is connected to a utility power source 16, and includes meter 18, load control device (LCD) 20 with relay 22, and load 24. LCD 20 is typically electrically connected in series with a main power line supplying power to load 24. In most regions, load 24 is most often a compressor of an air-conditioning system. Facility 12 may also include various devices D1, D2, and D3 that may be part of the heating ventilating and air-conditioning (HVAC) system of facility 12, or may be one of other household appliances. Devices D1-D3 are not communicatively coupled to master station 10, nor any local or short-haul network.

In this system, when the utility is not asserting control over any of the devices or appliances of facility 12, meter 18 monitors and measures power supplied to facility 12, while LCD 20 permits power to flow through relay 22 to load 24, thereby allowing load 24 to operate normally. Meter 18 communicates usage data over long-haul network 30.

When a utility chooses to control the energy usage of a particular building or group of buildings, the utility, via master station 10, transmits a load-control message over long-haul network 14 to buildings 12. LCD 20 receives the message and opens relay 22, thereby interrupting power to load 24. An example of such an LCD device is disclosed in U.S. Pat. No. 7,355,301. U.S. Pat. No. 7,355,301 is commonly assigned to the assignee of the present application, and is herein incorporated by reference.

In the relatively simple system of FIG. 1, facility 12 is linked to the utility and master station 10 through LCD 20 over network 14, and separately with meter 18 over network 30, and no local or short-haul network exists.

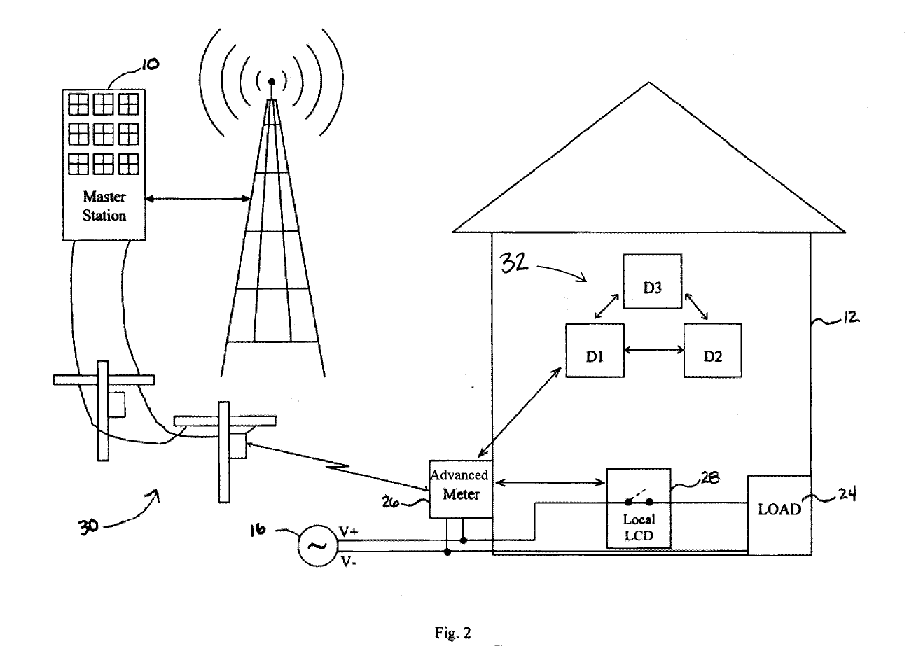

Referring to FIG. 2, a significantly more sophisticated communication network and system of managing an energy load is depicted. Unlike the previously-described system, the system of FIG. 2 includes an advanced communicative meter 26 that communicates with both the utility and local devices. Meter 26 may be a “smart meter” tied into an Advanced Meter Infrastructure (AMI) or a “smart grid”, capable of communicating with the utility over long-haul network 30, and communicating with local devices, such as LCD 28 and devices D1-D3 over a short-haul network 32. By optimizing distribution and usage of energy, a smart grid reduces overall energy usage and costs, while increasing overall reliability. Smart meters play a significant role in a smart grid.

Advanced meter 26 typically functions as a 2-way communicative device, transmitting and receiving messages over long-haul network 30, as well as over short-haul network 32. Advanced meter 26 also serves as a gateway, bridging long-haul network 30 with short-haul network 32, such that master station 10 may communicate with devices D1 to D3 on short-haul network 32. Short-haul network 32 most commonly is a home-area network operating in compliance with standards such as ZigBee®, ZigBee Smart Energy Profile, Z-Wave®, Bluetooth®, HomePlug®, and so on.

The advanced system of FIG. 2 that includes advanced meter 26 serving as an energy portal coordinating the energy-saving functions of load-control device 28 and local devices D provide an optimum solution for actively managing the energy usage at a facility 12 as part of a larger smart-grid energy solution.

Referring to both FIGS. 1 and 2, ideally, all commercial and residential buildings would replace conventional meters 18 with advanced meters 26, long-haul LCDs 20 with local LCDs 28, and add local energy-saving devices D, thereby participating in the region-wide energy-savings solution described in FIG. 2. Indeed, utilities are busy making significant investment in infrastructure and equipment as part of a greater effort to control and reduce energy usage. However, until the energy-saving infrastructure required of FIG. 2 is universally employed, and equipment changed out, both conventional and advanced load-control equipment and programs continue to be added to new and existing buildings 12.

For example, conventional load-control devices, such as LCDs 20 continue to be added to facilities 12 in conjunction with load-management programs run by utilities. Energy-saving devices, some of them network-capable, may also be added prior to the introduction of AMI and smart-grid technology. ZigBee-compliant thermostats may function as a local coordinator for ZigBee-compliant appliances and other devices to form a local network aimed at saving energy.

Unfortunately, when a conventional, long-haul load-control device such as LCD 20 is added to a facility 12 as part of a pre-smart-grid load-management program as depicted in FIG. 1, when an upgrade to AMI is desired, LCD 20 must be discarded in favor of a new load-control device capable of participating as a device on a local network, and following the commands of advanced meter 26. The need to change out the LCD and other equipment may deter utilities from installing conventional LCDs 20, or may cause them to defer the rollout of smart grid and AMI technology.

An interim device for controlling loads that works with existing utility load-management programs without requiring replacement of the device when an upgrade to AMI is implemented, would encourage the expansion of existing load-management programs and increase the adoption of AMI and smart-grid technology.

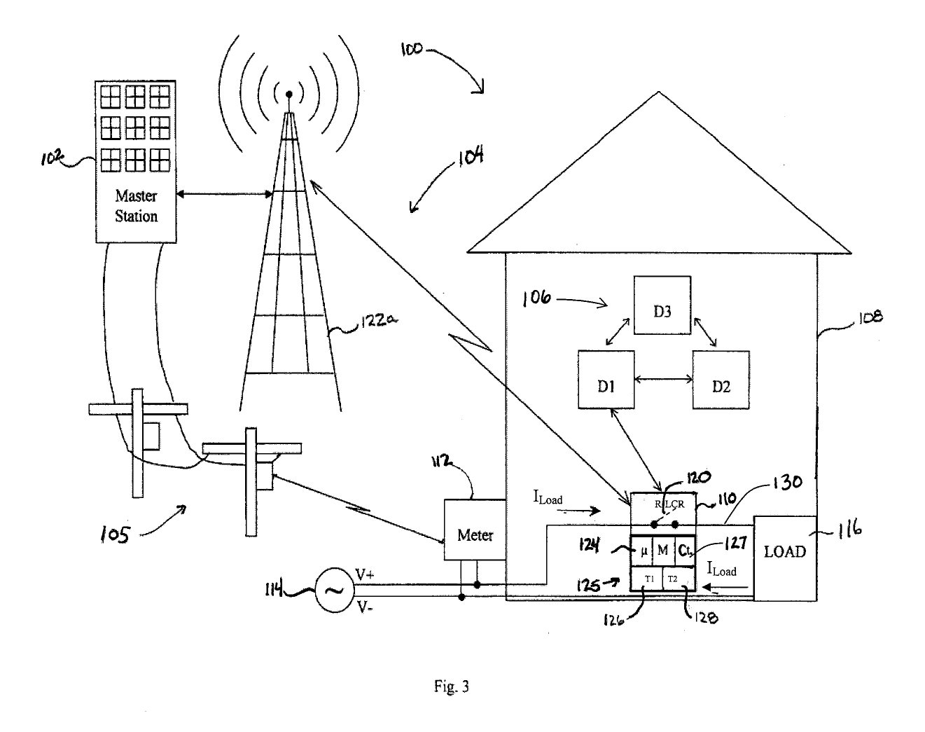

One such interim device is depicted in FIG. 3. Reconfigurable load-control system 100 includes master station 102, first long-haul communications network 104 utilizing at least a first communications protocol, short-haul communications network 106 utilizing at least a second communications protocol, one or more facilities 108, reconfigurable load-control receiver (reconfigurable LCR) 110, meter 112, power source 114, load 116, and local devices D1, D2, and D3. Utility master station 102 is communicatively linked to short-haul network 106 and facility 108 via first long-haul network 104. In this particular configuration, devices D1 to D3 are communicatively linked to reconfigurable LCR 110 as part of short-haul network 106. Load 116 is electrically coupled to power source 114 through reconfigurable LCR 110 and its switching device 120. Meter 112 is also electrically coupled to power source 114. In this configuration, and as discussed further below, reconfigurable LCR 110 assumes the role of a gateway or coordinator.

Master station 102 is a control station, typically of an electrical utility, that facilitates the forming, transmission, and receipt of data communications relating to the distribution and control of energy in the energy grid.

First long-haul communications network 104 is linked to master station 102, and facilitates one-way or two-way communications, with transmission of data accomplished using a variety of known wired or wireless communication interfaces and protocols including power line communication (PLC), broadband or other interne communication, radio frequency (RF) communication, and others.

In the depicted embodiment, first long-haul network 104 is an RF network transmitting and receiving data via radio towers 122a. Network 104 can be implemented with various communication interfaces including, for example, VHF or FLEX one-way paging, AERIS/TELEMETRIC Analog Cellular Control Channel two-way communication, SMS Digital two-way communication, or DNP Serial compliant communications for integration with SCADA/EMS communications currently in use by electric generation utilities.

As will be discussed further below, short-haul network 106 in the depicted configuration includes reconfigurable LCR 110 communicating with devices D1, D2 and D3. Devices D1, D2, D3 may not initially be present when reconfigurable LCR is initially installed at facility 108, but may be added later.

Generally, short-haul network 106 may be a wired or wireless communication network capable of communicating over a relatively short range. Short-haul network 106 may comprise a local network with coverage that potentially extends somewhat beyond the confines of facility 108, or may be a building-centric network, such as a wireless personal area network (WPAN), home-area network (HAN), home plug network, building area network, or similar network. As depicted, short-haul network 106 is a wireless network with range limited to the immediate vicinity of facility 108.

Short-haul network 106 may operate using a variety of wired or wireless network topologies, and protocols. Though not exhaustive, this includes wireless mesh networking, and a variety of associated wireless protocols such as ZigBee®, Wi-Fi®, Z-Wave®, Bluetooth®, and others. As depicted, short-haul network 106 is a wireless mesh network, though in other embodiments, the topology of short-haul network 106 may include a tree, star, ring, hub-and-spoke, or other known topology. In one embodiment, messages communicated over short-haul network 106 are formatted according to a second communications protocol that may be different from the first communications protocol of first long-haul network 104. In one such embodiment, the first communications protocol is a proprietary protocol, such as Expresscom, and the second communications protocol is a standardized protocol, such as the ZigBee protocol.

Facility 108 may be any type of residential, commercial or other building or structure. In the embodiment depicted, facility 108 is a residential house.

As will be discussed further below, reconfigurable load-control receiver (reconfigurable LCR) 110 serves as a load-control device, but also may serve as a gateway, coordinator, or other similar such bridging device. Reconfigurable LCR 110 in one embodiment includes housing 124, switching device 120, and controller 125.

In one embodiment, switching device 120 is a relay. Switching device 120 may also include, or be electrically connected, to additional devices to aid the modulation of power to load 116, including one or more contactors.

Controller 125 includes first transceiver 126, second transceiver 128, and additional electronic components and circuitry such as one or more processors, memory, power supply and conditioning circuits, relay driver circuits, and so on. In one embodiment, controller 125 includes switching-device controller 127, also known as a demand-response communications module, that is designed to facilitate the functioning of reconfigurable LCR 110 as a load-control device, or a controller of switching device 120.

In one embodiment, transceiver 126 facilitates receipt and/or transmission of load-control messages over first long-haul network 104 according to the first protocol, while transceiver 128 facilitates receipt and/or transmission of load control messages over short-haul network 106 according to the second protocol. In one embodiment, transceiver 126 is a receive-only device, or a receiver. Transceiver 128 in one embodiment may be a stand-alone ZigBee-compliant transceiver chip, or in other embodiments may be a ZigBee transceiver chip that includes integrated components, such as a microcontroller and memory, as well as a ZigBee software stack.

The memory of reconfigurable LCR 110 may store software programs for performing various operations described in further detail below, including programs for translating long-haul first-protocol messages to short-haul network second-protocol messages, for establishing and maintaining short-haul network 106, controlling switching device 120, and for other functions. Switching device 120 of SCF-LRC 110 is electrically connected in series with one line of power source 114, line 130, between power source 114 and load 116.

Devices D1, D2, and D3 are devices, or “nodes” in a networking sense, located within or near facility 108 and form part of short-haul network 106. Devices D1 to D3 may be part of the heating ventilating and air-conditioning (HVAC) system of facility 108, or may be one of other household appliances. Such “smart” devices may include thermostats, appliances such as washers or dryers, lighting fixtures, motorized window shades, or other such devices. Devices D1 to D3 may also include in-home displays of the type that may be used in home-area networks. Although not restricted to such devices, devices D1 to D3 will typically either be energy-consuming devices, or devices that affect energy consumption of facility 108. Further, though three devices D are depicted for the purposes of illustrating the network, more or fewer devices D may be coupled as nodes to short-haul network 106.

Meter 112 is electrically coupled to mains power of power source 114 and measures and monitors energy usage at facility 108. Meter 112 as depicted is an electricity meter and may have relatively limited communicative capability, and is generally not in communication with short-haul network 106. In one embodiment, meter 112 communicates over a long-haul network that may be part of first long-haul network 104. In other embodiments, and as depicted, meter 112 communicates over second long-haul network 105 that may include a combination of cable, telephone, Internet, and possibly even short to medium range networks utilizing local repeaters or other such known devices. Communication may be one-way or two-way as depicted, and in accordance with the first communications protocol as described above, or in accordance with a third communications protocol. As such, meter 112 may be part of an advanced meter reading (AMR) system capable of reporting data back to a utility or master station, but otherwise generally has limited networking and communicating capabilities with respect to first long-haul network 104.

During normal operation, or off-peak demand times, master station 102 may not be asserting control over load 116, such that current I_{LOAD} may flow as needed without interruption to load 116. During times of peak demand, power to load 116 may be interrupted periodically by the controlled opening of switching device 120 of reconfigurable LCR 110. The control of switching device 120 is facilitated by controller 125 of reconfigurable LCR 110, and may control switching device 120 by cycling switching device 120 on and off in real-time in response to load control messages. In other embodiments, load-control commands that define operation of switching device 120 may be received by reconfigurable LCR 110 over first long-haul network 104, stored in a memory of reconfigurable LCR 110, and executed at the appropriate time.

More specifically, master station 102 responds to a peak demand call for electricity by formatting one or more load-control messages according to the first communications protocol, and causing the messages to be transmitted over first long-haul network 104 to reconfigurable LCR 110. Such load-control messages may be broadcast or transmitted to a plurality of buildings and reconfigurable LCRs 110 located in a predefined region, such as a geographic region, or to individual facilities 108 with reconfigurable LCRs 110. Load control messages may be addressed for recognition by individual reconfigurable LCRs 110, or by groups of reconfigurable LCRs 110. In one embodiment, the first communications protocol is the proprietary communications protocol, Expresscom®, developed by the assignee of the present invention and defining load-control message fields that include a message start indicator, message address, message type, fixed or variable-length command data, and a message terminator. While not limited to embodiments disclosed therein, U.S. Pat. No. 7,702,424, entitled “Utility Load Control Management Communications”, and incorporated by reference herein, provides further detail and examples of the Expresscom protocol and associated load-control messages.

Load-control messages may include a number of different types of commands directed to control the operation of reconfigurable LCR 110 with respect to its operations as a load-control device (node) and as a gateway. As discussed further below, load-control messages may also be directed to devices D1, D2, and D3 of short-haul network 106. Though not an exhaustive list, load control messages may include commands or data generally directed to device control, synchronization, configuration, testing, maintenance, and so on.

As depicted in FIG. 3, in one embodiment, system 100 is RF-based, with first transceiver 126 of reconfigurable LCR 110 being adapted to communicate with master station 102 over first long-haul network 104 according to the first communications protocol. Transceiver 126 receives a load-control message transmitted from master station 102 over first long-haul network 104. As received, the payload or commands of the load-control message formatted according to the first communications protocol may be readily understood by controller 125 and its switching-device controller 127, but may not be in a format that may be readily understood by devices D of short-haul network 106, which operate according to the second communications protocol. In one embodiment, the load-control message is an Expresscom formatted load-control message as described above, that includes payload messages intended for ZigBee devices D on short-haul network 106. In one such embodiment, controller 125 decodes or translates the load-control message received at reconfigurable LCR 110 as needed, for example into a ZigBee protocol, and sends the message to the appropriate device D for execution.

In one embodiment, commands and data of the load-control message are directed to control of load 116 via switching device 120. Such messages are identified and directed to switching-device controller 127 and switching device 120 for controlling load 116. In some embodiments such load-control messages do not require translation, as relay controller 127 is configured to receive and process load-control messages formatted according to the first communications protocol. In one such embodiment, the load-control message is formatted in Expresscom and includes commands and data directed to the control of load 116. Controller 125 of reconfigurable LCR 110 receives the load control message, determines that it is a message for control of load 116, and passes the message to relay controller 127 to direct the execution of the message. In one embodiment, this capability of reconfigurable LCR 110 to control load 116, unless otherwise disabled, persists whether reconfigurable LCR 110 functions as a gateway or a node.

Further, the cycling of switching device 120 in response to load-control messages occurs relatively independent of whether a short-haul network 106 with devices D1, D2, and D3 exist. Although short-haul network 106 is depicted in FIG. 3, in other embodiments, system 100 may not initially include such a network and devices. This may be especially true in the case where reconfigurable LCR 110 is installed prior to devices D1 to D3. In such a case, reconfigurable LCR 110 via controller 127 will appropriately control switching device 120 as part of a demand response program initiated and controlled by master station 102, but will not initiate or participate in short-haul network 106 until the appropriate devices D1 to D3 are installed in facility 108. In one embodiment, controller 127 may be considered a single node in a local network when no other devices D are present.

When one or more devices D1 to D3 are installed at facility 108, reconfigurable LCR 110 will establish short-haul network 106 and begin to function in a gateway role to administer the network, connecting first long-haul network 104 to short-haul network 106. If, for example, the load-control message includes command data directed to devices D1 to D3 of short-haul network 106, controller 125 translates the load-control message to a format or protocol appropriate for devices operating on short-haul network 106, and transceiver 128, transmits the translated load-control message to devices D1, D2, and D3. In one embodiment, the received load-control message is formatted according to the first communications protocol, is translated by reconfigurable LCR 110 to the second communications protocol, and transmitted to devices D1, D2, D3. In one such embodiment, the first protocol is a proprietary protocol, and the second protocol is one of ZigBee, Bluetooth, Z-Wave, Wi-Fi, or other known wireless protocols.

In such a configuration, whereas reconfigurable LCR 110 establishes and facilitates short-haul network 106, reconfigurable LCR 110 functions as a network coordinator or gateway. The term gateway will be understood to refer generally to a device for interconnecting two networks, a long-haul network such as network 104, and a short-haul network, such as short-haul network 106. The term gateway as used herein is intended to encompass such devices as referred to and defined by known standards, including terms such as coordinator (ZigBee and others), energy-services portal (ESP), energy-services interface (ESI) or smart energy interface (e.g., ZigBee Smart Energy Profile 2.0), and other such terms.

Generally, in the configuration as depicted in FIG. 3, conventional meter 112 communicates with master station 102 over first long-haul network 104 to communicate data such as power usage and other associated data collected by meter 112. In another embodiment, meter 112 may not be a communicating meter. In either case, as depicted, meter 112 does not generally communicate with short-haul network 106.

As discussed briefly above, short-haul network 106 may be a wireless mesh network implementing wireless protocols such as ZigBee, Wi-Fi, Z-Wave, Bluetooth, and others. In the embodiment where reconfigurable LCR 110 establishes a ZigBee network, reconfigurable LCR 110 functioning as a gateway may be a ZigBee coordinator, an ESP, ESI, or similar term as understood and defined by the ZigBee Alliance standards that include IEEE 802.15.4 and the ZigBee Smart Energy Profile 2.0, which are herein incorporated by reference in their entireties.

In the embodiment wherein reconfigurable LCR 110 establishes a ZigBee network, reconfigurable LCR 110 receives messages under the first protocol directed to devices D1, D2, D3 over long-haul network 104 via transceiver 126, translates the load-control messages into second protocol messages, ZigBee messages, and routes or transmits the ZigBee messages to short-haul network 106 via transceiver 128. An embodiment of the translation process is described further below. Devices D1, D2, D3 may be ZigBee end devices, including smart energy devices, which receive and transmit messages in accordance with ZigBee standards. In some cases, one or more of devices D1, D2, D3 may be a ZigBee router, routing messages between devices.

Although devices D are not limited exclusively to the purposes of energy savings, those devices D1 to D3 operating in accordance with a ZigBee Smart Energy Profile may communicate and function to reduce overall energy usage in facility 108. In one embodiment, device D1 may be a ZigBee-capable thermostat that receives temperature programming commands designed to adjust a space temperature of a portion of facility 108. In another embodiment, device D2 may be a ZigBee-enabled smart appliance, such as a dishwasher, receiving commands to operate during off-peak hours. Device D3 may be a controller for a set of window shades designed to close during the sunniest times of the day during the summer months.

In such an embodiment, in conjunction with the cycling of switching device 120, master station 102 transmits to, and receives data from, reconfigurable LCR 110 over a long-haul network 104 to improve the overall energy-efficiency of facility 108.

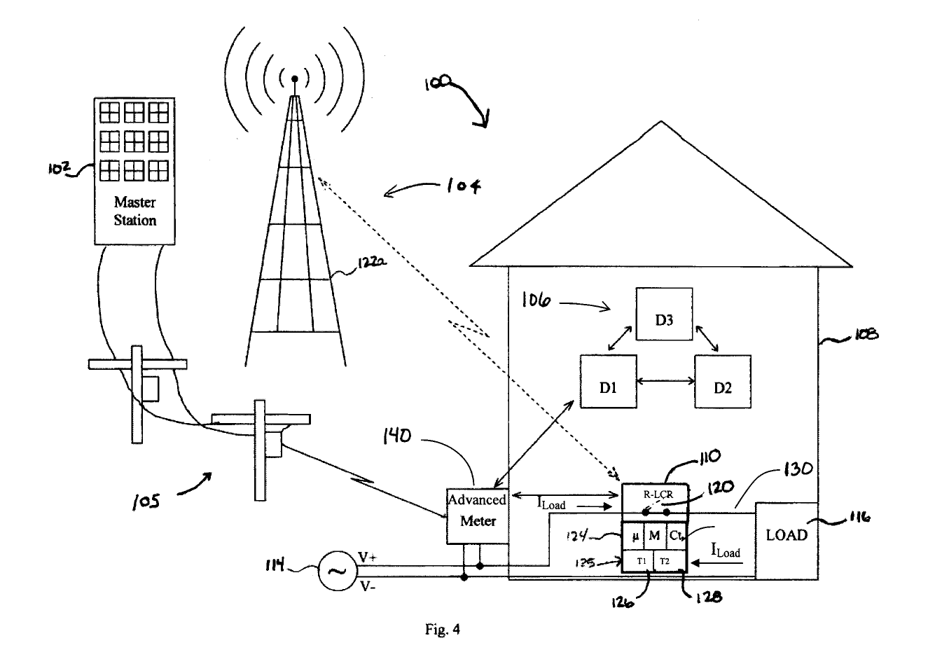

The embodiment of system 100 as depicted in FIG. 3 includes conventional meter 112 with limited networking capabilities, and reconfigurable LCR 110 configured to operate as a local gateway or coordinator in short-haul network 106. Should a utility in conjunction with an owner or operator of facility 108 choose to upgrade system 100 into an AMI system by installing an advanced meter, smart meter, or other device that is capable of serving as the coordinator or gateway for short-haul network 106, reconfigurable LCR 110 may reconfigure itself to abdicate its role of short-haul network 106 gateway, and become an end device (with or without routing capabilities) in short-haul network 106. Such an embodiment of system 100 is depicted in FIG. 4.

Referring to FIG. 4, the depicted embodiment of system 100 is similar to the embodiment depicted in FIG. 3, though system 100 of FIG. 4 includes advanced meter 140, rather than conventional meter 112, and reconfigurable LCR 110 is configured to act as an end device, or node, of short-haul network 106.

Advanced meter 140 in one embodiment is a “smart meter” or an AMI meter that forms part of a utility's smart grid. In the embodiment depicted, meter 140 communicates in two-way fashion with master station 102 over second long-haul network 105. Meter 140 receives load-control messages from master station 102 or another communications station, and collects and transmits data regarding energy or commodity usage back to master station 102. In one embodiment, these load-control messages are formatted according to a third protocol. As will be understood by those skilled-in-the-art, in addition to energy usage, advanced meter 140 may also detect and transmit data relating to system status, line-voltage and frequency, unauthorized usage, and other such information. In one embodiment, meter 140 is an electrical meter, but in other embodiments may be a gas, water, or other such meter.

As depicted, advanced meter 140 also assumes the role of gateway for short-haul network 106, replacing reconfigurable LCR 110 as the local gateway to a long-haul network and master station 102. Reconfigurable LCR 110 becomes a node of short-haul network 106 until, or unless, called upon to serve as a local gateway.

In previously-known systems, an upgrade to AMI technology required not only the replacement of conventional meter 112 with advanced meter 140 but also required the replacement of a local load-control device 20 as depicted in FIGS. 1 and 2. However, reconfigurable LCR 110 may be installed at facility 108 providing load-control capability regardless of the level of technology of other system components, including the meter. At its simplest, reconfigurable LCR 110 receives load-control messages from master station 102 via first long-haul network 104 and cycles switching device 120 on and off to reduce energy usage. If one or more local devices D are added to facility 108, for example a ZigBee thermostat, reconfigurable LCR 110 may serve as a ZigBee coordinator, translating and transmitting ZigBee commands to local devices as part of a coordinated energy-saving program that includes more than just the cycling of a single load. When an advanced meter 140 is introduced to facility 108, reconfigurable LCR 110 reconfigures itself to serve as an end device or node in short-haul network 106, receiving commands from advanced meter 140. In such a configuration, reconfigurable LCR 110 receives load-control messages sent over both second long-haul network 105 and short-haul network 106.

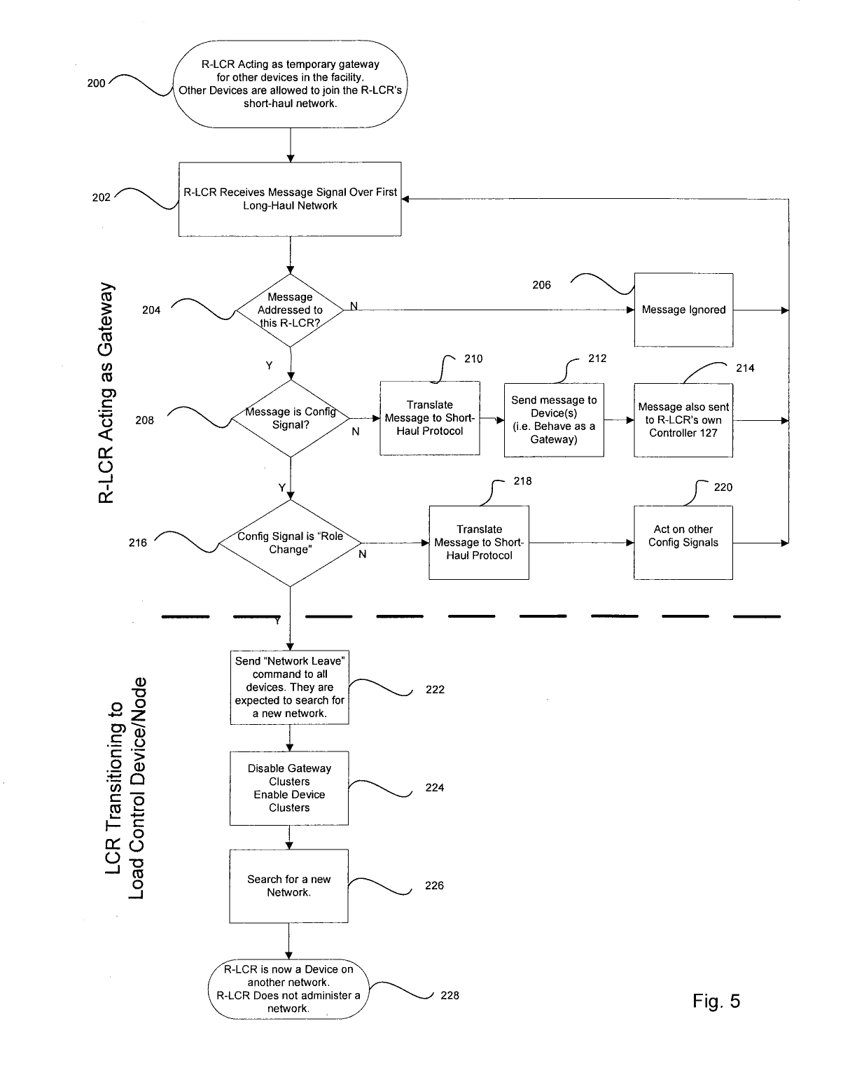

Referring to FIG. 5, the operation of reconfigurable LCR 110 initially configured to operate as a gateway according to FIG. 3 is depicted. In this particular embodiment, short-haul network 106 is a wireless mesh network in accordance with the ZigBee standard and Smart Energy Profile, though it will be understood that other short-haul network standards and protocols as discussed above could be used.

At step 200, reconfigurable LCR 110, is configured as a gateway, bridging first long-haul network 104 and short-haul network 106. Operating as a gateway, reconfigurable LCR 110 connects master station 102 and utility short-haul network 106 to energy managing, end-point devices such as D1 to D3, in facility 108 by routing, and as needed, translating, messages from master station 102 to devices D1 to D3.

At step 202, reconfigurable LCR 110 via transceiver 126 receives a load-control message formatted according to a first communications protocol over first long-haul network 104.

At step 204, reconfigurable LCR 110 determines whether the load-control message is addressed to reconfigurable LCR 110. If the load-control message is not addressed to reconfigurable LCR 110, then according to step 206, the load-control message is ignored.

At step 208, if the load-control message is addressed to reconfigurable LCR 110, the message is reviewed to determine whether the load-control message is a configuration message. A configuration message is a message directed to reconfigurable LCR 110 and is intended to update or verify one or more settings or configurations of reconfigurable LCR 110.

In some ZigBee-based embodiments, functionality of reconfigurable LCR 110 may be added or modified by configuration commands such as: configure ‘Permit Joining’ (ESI only) for a specific time duration; change Zigbee mode to ESI; change Zigbee mode Device; configure Flex paging parameters (capcode and frequency) (0x17, 0x18); configure Expresscom addressing (0x01); configure ESP—allowed devices (this configuration provides the EUI64 address and installation code of devices that are allowed on short-haul network 106); configure ESP—disallowed devices.

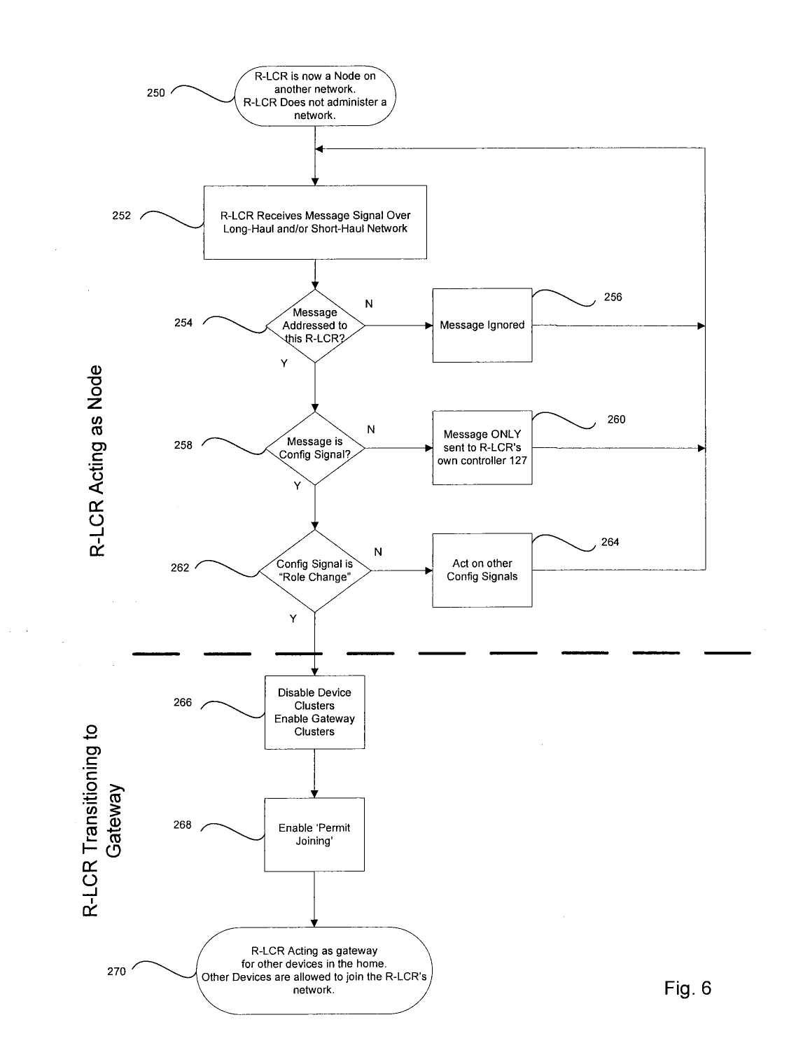

One particular type of configuration message is a “role change” configuration message. A role-change configuration message commands reconfigurable LCR 110 to modify its role in system 100. When acting as a gateway, or as an ESP/ESI in the case of a ZigBee network, a role-change configuration message requests reconfigurable LCR 110 to give up its role as a gateway, and to reconfigure itself to act only as a load-control device, or a node on the network. Conversely, when acting as device node, a role change message might request that reconfigurable LCR 110 reconfigure itself to act as a gateway. The configured role is stored in non-volatile memory. This configured memory is used to switch between the flow steps shown in FIG. 5 and the flow steps shown in FIG. 6. In a ZigBee network it is also used to enable and disable certain clusters, and to show the same during service discovery.

In the embodiment depicted in FIG. 5, reconfigurable LCR 110 is initially acting as a gateway. If at step 208, reconfigurable LCR 110 determines that the received load-control message is not a configuration message, the load control message is translated from a first communications protocol to a second communications protocol at step 210. In one embodiment, the load-control message is translated to a ZigBee protocol.

The translation of load-control messages formatted according to a first communications protocol to a message formatted according to a second communications protocol comprises a process of reformatting by mapping data from data fields of the first protocol to data fields of the second protocol. In one embodiment, each data field of a load-control message formatted according to the first communications protocol is correlated with, or mapped to, a corresponding one or more fields of a message to be constructed according to the second communications protocol. For example, a field of a data frame of the original load-control message may be dedicated to designating a message type. The field corresponding to message type is identified in the data frame of a message format of the second communications protocol. Such a field map may be stored in a look-up table, determined dynamically as part of the translation process, in whole, or in part, or may otherwise be determined based on a known relationship between the data formats of the first and second protocols.

In some embodiments, data from each field of the load control message of the first communications protocol must also be mapped to, or translated to, equivalent data of the second communications protocol. For example, a command designated by the bits 0x17 in the first communications protocol may be designated 0x84 in the second communications protocol.

As such, a set of relationship rules or a map correlating a first message format with a second message format allows the original load-control message to be translated into a load-control message of the second communications protocol. As those skilled in the art will understand, a software translation module of reconfigurable LCR 110 and corresponding algorithm may be constructed based upon the relationship rules or map between the two protocols such that any load-control message of the first communications protocol may be translated into a corresponding load-control message of the second communications protocol.

An example set of relationship rules for the embodiment wherein the first communications protocol is the Expresscom protocol and the second communications protocol is the protocol of the ZigBee Specification and the ZigBee Smart Energy Profile, is provided in Attachment A, which is incorporated herein in its entirety. Attachment A provides details of how to map messages from an Expresscom protocol to messages of a ZigBee protocol, including messages for Zigbee clusters relating to identification, key establishment, reporting, power configuration, alarms, commissioning, messaging, pricing, demand response/load control, timing, complex and simple metering, prepayment, and so on.

It will be understood that the same, or a similar, set of relationship rules or map may be used to translate from the second communications protocol to the first communications protocol, which is referred to and described below with respect to FIG. 6.

Still referring to the translation process, one of the first or second communications protocol may allow a more extensive set of load-control messages or commands. In one embodiment, the first communications protocol includes load-control messages that cannot be directly mapped to, or formatted in, the second communications protocol. For instance, although standardized protocols such as ZigBee provide the benefit of universal communicability, the standardized nature of the protocol may limit the ability to provide unique or custom features or commands that may be desirable for a particular device or application.

In one such embodiment, the first communications protocol is a proprietary protocol, such as Expresscom, and the second communications protocol is ZigBee. Certain unique commands directed to controlling load 116 may not be easily translated into the ZigBee protocol. For example, a command to curtail the operation of load 116 based in part on the actual time that load 116, for example, a compressor, operates, does not map directly to a known type of ZigBee command message. For such messages that cannot be readily mapped, rather than relying solely on the translation method described above, a tunneling process that encapsulates a message of one protocol inside the message of another protocol, may be used.

In one embodiment, a message supported by the first communications protocol, but not directly supported by the second communications protocol, needs to be transmitted to reconfigurable LCR 110 for execution while acting primarily as a load-control device. In this embodiment, a first message is formatted according to the first communications protocol. A second message is then created according to the second communications protocol, the second message bearing the first message embedded into a data or payload portion of the second message. The second message is then transmitted as a message of short-haul network 106 to reconfigurable LCR 110. Reconfigurable LCR 110 receives the second message via transceiver 128, strips out the data portion of the message, namely the first message of the first protocol, and directs it to controller 127 for execution.

In the embodiment wherein short-haul network 106 is a ZigBee network, a second message may be formatted as a ZigBee message, with a first message according to the first protocol, encapsulated in the second ZigBee message. The ZigBee Standard and Smart Energy Profile supports such encapsulation through its Smart Energy Tunneling (Complex Metering) Cluster.

Still referring to FIG. 5, at step 212, reconfigurable LCR 110 fulfills its function as a gateway and sends the translated message to the appropriate device D coupled to short-haul network 106.

At step 214, the load-control message may be sent to relay controller 127 of reconfigurable LCR 110 to be acted upon. In one embodiment, the load-control message is sent without translation, while in another embodiment, the load-control is translated. In an embodiment not requiring translation, the load-control message is received by relay controller 127 as an Expresscom formatted message.

At step 216, the load-control message is known to be a configuration message, and if the load-control message is a “role-change” message, reconfigurable LCR 110 begins transitioning to act primarily as a load-control device, rather than a gateway or an ESI, as described below with respect to steps 222 to 228. If the load-control message is not a role-change configuration message, and is not in a protocol or format readily understood by devices of short-haul network 106, then at step 218, the load-control message is translated into a format of the second protocol, a ZigBee format in one embodiment, at step 218. At step 218, the message is transmitted to devices D on short-haul network 106, and acted upon per step 220. Received non-role-change configuration messages may also be acted upon directly by reconfigurable LCR 110 in its capacity as a load-control device via relay controller 127 and switching device 120.

Up to this point, reconfigurable LCR 110 serves not only as a control device for load 116, but also as a gateway for short-haul network 106 and its devices D1, D2, and D3. However, upon receiving a role-change configuration message, reconfigurable LCR 110 changes from acting as a short-haul network 106 gateway to a short-haul network 106 device/node.

In one embodiment, the call for reconfigurable LCR 110 to abdicate the role of gateway results from an introduction of an AMI or smart meter 140 into system 100. As AMI and smart grid technology advances into more and more regions, conventional meters 112 are eventually replaced by utilities with advanced meters 140. When advanced meter 140 is introduced into system 100, the interim solution of reconfigurable LCR 110 serving as a gateway is no longer necessary. The updated system 100 of FIG. 4 still includes short-haul network 106 comprised of devices D1, D2, and D3 serving as nodes, but now reconfigurable LCR 110 becomes a node of short-haul network 106, and meter 140 takes over as a potentially more sophisticated gateway.

Still referring to FIG. 5, at step 222, reconfigurable LCR 110, after receiving the role-change command, sends a message over short-haul network 106 to devices D1 to D3, commanding the devices to leave short-haul network 106 and search for a new network. When short-haul network 106 is a ZigBee network, reconfigurable LCR 110 transmits a “Network Leave” command to devices D, instructing the devices to leave the previously-established short-haul network 106. Devices D are left to search for a new network, find meter 140, and form a new short-haul network 106.

At step 224, reconfigurable LCR 110 disables its gateway functionality and enables device functionality. More specifically, when short-haul network 106 is a ZigBee network, reconfigurable LCR 110 disables specific gateway-oriented functionality by disabling ESI clusters stored in the memory of controller 125, and enables device-oriented functionality, known as “device clusters”. During Zigbee “Service Discovery” each device describes its available cluster. Reconfigurable LCR 110 will list a different cluster list after the role change. In one embodiment, reconfigurable LCR 110 will begin to serve as a ZigBee device with message-routing capabilities. In another embodiment, reconfigurable LCR 110 will serve as an end device without router characteristics.

The role change configuration command therefore triggers an automatic switchover of reconfigurable LCR 110 from gateway to device, without requiring removal and/or replacement of reconfigurable LCR 110. In systems previously known in the art, an AMI upgrade requires removal or at least manual reprogramming of the device serving as the ZigBee gateway of short-haul network 106.

At step 226, after reconfiguring itself to act as a load-control device, reconfigurable LCR 110 searches for a new network, finds short-haul network 106 with meter 140 acting as a gateway or portal, and joins short-haul network 106 as a device at step 228.

Configured as a load-control device (node) and not as a gateway, reconfigurable LCR 110 participates in short-haul network 106, receiving and transmitting load-control or other messages over transceiver 128. In one embodiment, advanced meter 140 serving as a gateway receives load control messages over its second long-haul network 105, and transmits load-control messages formatted for short-haul network 106 to reconfigurable LCR 110 and other devices D. In an embodiment wherein short-haul network 106 is a ZigBee network, reconfigurable LCR 110 receives and executes ZigBee-formatted messages received from the local ZigBee gateway, advanced meter 140.

In one such embodiment, reconfigurable LCR 110 receives a ZigBee-formatted message for controlling load 116. Switching-device controller 127 receives the message data without translation, and executes any commands of the load-control message, such as cycling switching device 120, for example. In an alternate embodiment, reconfigurable LCR 110 translates the ZigBee-formatted message to a format of the first communications protocol of first long-haul network 104 prior to communicating the message to switching-device controller 127. The translation from the second communications protocol to the first communications protocol is discussed above.

In another embodiment, load-control messages sent over second long-haul network 105 may be formatted according to a third communications protocol that may be different from the second protocol of short-haul network 106, so as to accommodate communications with advanced meter 140 and the newly introduced AMI. For example, second long-haul network 105 may connect a utility with an advanced meter over telephone, cable, or other Internet-based infrastructure. Further, load-control messages may or may not require translation into a format compatible with short-haul network 106. In one embodiment, a utility transmits ZigBee-formatted commands embedded in the load-control message that do not require translation prior to broadcasting to short-haul network 106 operating as a wireless mesh network.

As discussed above, once reconfigurable LCR 110 reconfigures itself to act as a local device, or node, data is sent and received via controller 125 and transceiver 128. However, despite the reconfiguration from a gateway to a node, reconfigurable LCR 110 retains its capability to receive and transmit messages over first long-haul network 104 via transceiver 126. Provided that transceiver 126 is not disabled, reconfigurable LCR 110 continues to monitor and receive messages. This provides a number of benefits to system 100.

A first benefit is the ability to direct reconfigurable LCR 110 over first long-haul network 104 to reconfigure itself from a load-control device to a gateway. A role-change command may be sent via first long-haul network 104 and executed by reconfigurable LCR 110.

A second benefit is the inherent redundancy of the dual-transceiver device. Should advanced meter 140 or second long-haul network 105 fail for some reason, a message may be sent over first long-haul network 104, or in some cases over second long-haul network 105, to reconfigurable LCR 110. Such a message might command reconfigurable LCR 110 to reconfigure itself as a gateway, as is discussed further below with respect to FIG. 6. In other situations, such a message might be directed to advanced meter 140, or one or more of devices D1, D2, or D3, with reconfigurable LCR 110 serving as a routing device and/or translator as needed.

Referring to FIG. 6, and as described by steps 250 through step 270, reconfigurable LCR 110 initially functions as a node of short-haul network 106, but then configures itself to function as a gateway. Although the embodiment depicted in FIG. 6 refers generally to short-haul networks and devices being ZigBee capable, as discussed above, other short-haul network protocols and standards, including Wi-Fi, Bluetooth, Z-Wave, and others may be used.

Initially, at step 250, reconfigurable LCR 110 is operating as a load-control device node as described above. In this configuration, reconfigurable LCR 110 does not function as a gateway, nor administer a network, rather functions as a node on short-haul network 106. As such, in its capacity as a node, reconfigurable LCR 110 may continue to receive messages over short-haul network 106.

At step 252, reconfigurable LCR 110 receives a message sent over first long-haul network 104. As described above, the message may not require translation, such as a message formatted according to an Expresscom protocol as described above. In other embodiments, reconfigurable LCR 110 may receive a message sent over second long-haul network 105 via advanced meter 140; the message may or may not require translation.

At step 254, the message is reviewed to determine whether the message is addressed to this particular reconfigurable LCR 110. If the message is not addressed to reconfigurable LCR 110, the message is ignored at step 256.

If the message is addressed to reconfigurable LCR 110, the message is reviewed to determine whether the message is a configuration signal at step 258. If the message is not a configuration message, and because the message was addressed to reconfigurable LCR 110 while functioning as a node, at step 260, the message is acted upon by controller 125. In one embodiment, the message is sent to switching device controller 127 of controller 125 for execution of messages relevant to reconfigurable LCR 110 and its control over load 116.

At step 262, if the message is not a role-change configuration message, the message is acted upon at step 264. If the message is a role-change configuration message, than at step 266, the functionality relating to reconfigurable LCR 110 serving as a device of short-haul network 106 is disabled. Further, functionality relating to reconfigurable LCR 110 serving as a gateway is enabled. When short-haul network 106 is a ZigBee network, specific device clusters or functionalities are disabled, while gateway or ESI clusters are enabled. In one ZigBee-based embodiment, during ZigBee “Service Discovery” each device describes its available cluster. Reconfigurable LCR 110 will list a different cluster list after the role change.

At step 268, reconfigurable LCR 110 permits devices D to join short-haul network 106, which is now a reconfigured network with reconfigurable LCR 110 serving as the gateway or ESP of the short-haul network 106, as indicated at step 270.

Steps 252 to 270 as discussed above refer generally to the switchover of reconfigurable LCR 110 from node to gateway during normal operation, in response to commands sent over one of the two long-haul networks 104 and 105. However, the switchover of reconfigurable LCR from node to gateway may be in response to a failure of one of the communications networks 104, 105, or 106. In such a case, reconfigurable LCR 110 may be reconfigured manually via commands sent over an alternate operating communications network, or automatically in response to the detection of a network or systems failure.

In one embodiment, when reconfigurable LCR 110 is operating as a node and receiving commands over long-haul network 104 and short-haul network 106, in the event of a communications failure for any number of reasons, including failure of the network itself, failure of advanced meter 140, and so on, a configuration message may be transmitted over operable long-haul network 104 to reconfigurable LCR 110, requesting a change from node to gateway. Reconfigurable LCR 110 may then begin serving again as a gateway connecting long-haul network 104 and short-haul network 106, resuming communications and operation of reconfigurable LCR 110 and possibly devices D.

The transmission of a reconfiguration message over long-haul network 104 may be prompted manually by a utility following discovery of a network or system failure.

In other embodiments, the switch from node to gateway due to a network or system failure may be enacted automatically in response to a detected failure, such as in response to a lack of communication from advanced meter 140 for more than a predetermined period of time. In one embodiment, if after not receiving communications via second long-haul network 105 and/or advanced meter 140 for more than the predetermined period of time, reconfigurable LCR 110 may automatically switch from a node to a gateway configuration, without receiving a remote command.

Consequently, embodiments of the present invention provide energy management solutions that bridge the gap between earlier, simpler load-control technology and newer, AMI technology by providing methods and devices that can switch between both technologies, while providing failsafe operations.

Although the present invention has been described with respect to the various embodiments, it will be understood that numerous insubstantial changes in configuration, arrangement or appearance of the elements of the present invention can be made without departing from the intended scope of the present invention. Accordingly, it is intended that the scope of the present invention be determined by the claims as set forth.

For purposes of interpreting the claims for the present invention, it is expressly intended that the provisions of Section 112, sixth paragraph of 35 U.S.C. are not to be invoked unless the specific terms “means for” or “step for” are recited in a claim.

### ATTACHMENT A

### a) Load Control Event—Expresscom/Zigbee Translation

(1) Offset/Setpoint Control

This is generated when the SEP Load control event includes any of the temperature setpoints or offsets. If a valid setpoint and offset are received the setpoint field will be ignored.

Expresscom Function 0x3B: Dual Setpoint Ramp Control Message

| ExpressCom Field | Zigbee Field Load Control Event |
|---|---|
| Control Flags | 0x0002 if heat control is an absolute |
| | value, otherwise delta \| |
| | 0x0001 if cool control is an absolute |
| | value, otherwise delta |
| Heat Setpoint | Offset or Absolute as appropriate |
| | (Expresscom uses whole degrees F., |
| | whereas Zigbee sends as 0.1 degrees C.) |
| | If both offset and absolute are in the |
| | zigbee message, we will implement the |
| | offset only. |
| Cool Setpoint | Offset or Absolute as appropriate |
| | (Expresscom uses whole degrees F., |
| | whereas Zigbee sends as 0.1 degrees C.) |
| | If both offset and absolute are in the |
| | zigbee message, we will implement the |
| | offset only. |
| Duration | Control Duration (minutes) |

(2) Timed Load Control

This is generated when the Load Control event does not use the Duty Cycle, or the heat and cool setpoints or offsets.

Function Control 0x1A. Extended Cycle Load Control

| ExpressCom Field | Zigbee Field Load Control Event |
|---|---|
| Control Flags | 0x01: addressed to load 1 - thermostat |
| | 0x80: Control during rampin - setting |
| | this should have no functionally |
| | difference since rampin is suppressed, |
| | but in case of a bug, it is better to |
| | control here |
| | Other control bits cleared |
| Cycle % | 100 |
| Control Time | Duration in Minutes |
| Delay Time | Omitted |

(3) Cycle Load Control

This is generated when the Load Control event does contain the Duty Cycle, but not any of the temperature setpoints or offsets.

Expresscom Function 0x1A: Extended Cycle Load Control

| ExpressCom Field | Zigbee Field Load Control Event |
|---|---|
| Control Flags | 0x01: addressed to load 1 - thermostat |
| | 0x80: Control during rampin - setting |
| | this should have no functionally |
| | difference since rampin is suppressed, |
| | but in case of a bug, it is better to |
| | control here |
| | 0x40: True/Smartcycle used if |
| | Average Load Adjustment is between −1 |
| | and −100. |
| Cycle % | If True/Smartcycle = \|Average Load |
| | Percents\| |
| | Else = Duty Cycle (ceiling at 100) |
| Control Time | Duration in Minutes |
| Delay Time | Omitted |

### b) Priority

If the Load Control Event has a priority field, then this is implemented by concatenating a priority message 0x03 onto the beginning of the Expresscom load control message. ExpressCom Priority=15−Zigbee Priority.

The DR module will be modified to have the lowest priority be 15, rather than the current 3.

### c) Ending a Load Control Event

When the duration of an implemented event expires, an ExpressCom restore command will be sent out to ensure that the thermostat is not under control. This command should be redundant.
Function Control 0x09. Restore Load Control Message

| ExpressCom Field | Zigbee Field Load Control Event |
|---|---|
| Control Flags | 0x01: addressed to load 1 - thermostat |
| | 0x40: restore immediately |
| | Other bits are cleared |
| Cycle % | 100 |
| Control Time | Duration in Minutes |
| Delay Time | Omitted |

### 2. Cancel Load Control Event

SEP Spec D.2.2.3.2. When a cancel load control event command is ready to be immediately implemented (considering effective time and randomization), then the Zigbee module will take one of the following actions:
If the LCE is in the Zigbee queue, it will be removed.
If this LCE is received after the event has completed, or the event never existed or is invalid on some other way, then a “Report Event Status Command” is generated with a “Load Control Event command Rejected” status as per SEP Spec D.2.2.3.2.1.3
If the LCE is currently issue an ExpressCom 0x09 (Restore Load Control) command to the DR Module.
Function Control 0x09. Restore Load Control Message

| ExpressCom Field | Zigbee Field Load Control Event |
|---|---|
| Control Flags | 0x01: addressed to load 1 - thermostat |
| | 0x40: restore immediately |
| | Other bits are cleared |
| Cycle % | 100 |
| Control Time | Duration in Minutes |
| Delay Time | Omitted |

### 3. Cancel all Load Control Events

ExpressCom 0x09 (Restore Load Control), Control Flags=0 (all loads, immediate)

SEP Spec D.2.2.3.3 Cancel All Load Control Events command is received then the Zigbee module will clear all its currently stored events, and issue an
Function Control 0x09. Restore Load Control Message

| ExpressCom Field | Zigbee Field Load Control Event |
|---|---|
| Control Flags | 0x01: addressed to load 1 - thermostat |
| | 0x40: restore immediately |
| | Other bits are cleared |
| Cycle % | 100 |
| Control Time | Duration in Minutes |
| Delay Time | Omitted |

### Message Display Commands

### Expresscom Command 0x17 (Extended Tier)

| ExpressCom Field | Zigbee Field Load Control Event |
|---|---|
| Control Flags | 0x84 (Tier Rate included) |
| | (Tier Message included) |
| Tier Level | Tier Levels 0 to 4 are supported |
| | (ZigBee levels 5 and above are |
| | ignored) |
| Rate Amount | Current Rate in cents |
| Tier Message Length | Length of the Tier Label (always 12??) |
| Byte | |
| Tier Message | The Rate Label from the Publish Price |
| | command |

If a pricing event expires without data to replace it, or there is no pricing available on startup, issue the following command to clear the Tier Icon and any Usage screen information being displayed on the UPro:

| ExpressCom Field | Zigbee Field Load Control Event |
|---|---|
| Control Flags | 0x00 |
| Tier Level | Tier Levels 0 |

What is claimed is:

1. A method of operating a reconfigurable load-control receiver in initial communication with a first long-haul network and selectively adaptable to be reconfigured and in communication with a second long-haul network and to a short-haul network associated with a facility that includes the reconfigurable load-control receiver and an electrical load controlled by the reconfigurable load-control receiver, the method comprising:
operating a reconfigurable load-control receiver as a gateway for the first long-haul network to administer a short-haul network associated with the facility that includes the load-control receiver and an electrical load controlled by the reconfigurable load-control receiver, the load-control receiver controlling power delivered to the load in response to a load-control message received over the first long-haul network;
receiving at the reconfigurable load-control receiver a first role-change configuration message transmitted over the first long-haul network; and
in response to the first role-change configuration message, reconfiguring the reconfigurable load-control receiver to stop operating as the gateway and start operating as a node in a short-haul network such that another device in the short-haul network serves as a gateway to the second long-haul network, and wherein when the load-control receiver operating as a node controls power delivered to the load in response to a load-control message received over the second long-haul network and the short-haul network.

2. The method of claim 1, wherein the first long-haul network is a network selected from the group consisting of a power line communication network, an interne protocol network, a cellular network and a paging network.

3. The method of claim 2, wherein the first long-haul network comprises a paging network utilizing a paging protocol selected from the group consisting of one-way FLEX, two-way FLEX, VFH, ReFLEX, and POCSAG.

4. The method of claim 1, wherein the load-control message and the role-change message are formatted according to a first protocol, wherein the first protocol is selected from the group consisting of a one-way Expresscom protocol and a two-way Expresscom protocol.

5. The method of claim 1, wherein the short-haul network utilizes a communications protocol selected from the group consisting of ZigBee®, ZigBee Smart Energy Profile, Wi-Fi®, Z-Wave®, HomePlug® and Bluetooth®.

6. The method of claim 5, wherein the communications protocol is ZigBee.

7. The method of claim 6, operating the reconfigurable load-control receiver as the gateway for the first long-haul network to administer the short-haul network further comprises operating the reconfigurable load-control receiver as a gateway selected from the group consisting of a ZigBee energy services interface, a ZigBee energy services portal, a ZigBee coordinator, and a ZigBee gateway.

8. The method of claim 6, wherein the reconfigurable load-control receiver operating as a node in the short-haul network includes the reconfigurable load-control receiver operating as a ZigBee end device or a ZigBee router.

9. The method of claim 1, wherein the reconfigurable load-control receiver controlling power delivered to the load in response to a load-control message further comprises the reconfigurable load-control receiver causing a relay to interrupt power to a compressor of a heating, ventilating, and air-conditioning system.

10. The method of claim 1, wherein the another device in the short-haul network that serves as a gateway to the second long-haul network comprises a utility meter that serves as a gateway to the second long-haul network as part of an advance metering infrastructure.

11. The method of claim 1, further comprising adding one or more devices associated with the facility and acting as nodes on the short-haul network administered by the reconfigurable load-control receiver.

12. The method of claim 11, wherein adding one or more devices includes adding one or more devices selected from the group consisting of a thermostat, a water heater, a pool heater, a dishwasher, and a fan.

13. The method of claim 11, wherein operating a reconfigurable load-control receiver as a gateway for the first long-haul network to administer a short-haul network further comprises receiving a second load-control message over the first long-haul network according to a first long-haul protocol, translating the second message according to a protocol of the short-haul network, and transmitting to the nodes of the short-haul network.

14. The method of claim 1, wherein in reconfiguring the reconfigurable load-control receiver to stop operating as the gateway and start operating as a node in the short-haul network includes disabling gateway functionality and enabling node functionality and searching for a new short-haul network.

15. The method of claim 14, wherein the new short-haul network is the short-haul network administered by the other device and serving as the gateway to the second long-haul network.

16. The method of claim 1, further comprising:
receiving at the reconfigurable load-control receiver while the reconfigurable load-control receiver is operating as the node, a second role-change configuration message transmitted over either the first long-haul network or the second long-haul network; and
in response to the second role-change configuration message, reconfiguring the reconfigurable load-control receiver to stop operating as the node and start operating as the gateway.

17. A reconfigurable load-control receiver for initial communication with a first long-haul network and selectively adaptable to be reconfigured and in communication with a second long-haul network and to a short-haul network associated with a facility that includes the reconfigurable load-control receiver and an electrical load controlled by the reconfigurable load-control receiver, the reconfigurable load-control receiver comprising:
means for initially operating as a gateway connecting a short-haul network associated with a facility to a first long-haul network;
means for operating as a node in a short-haul network while another device in the short-haul network serves as a gateway to connect the short-haul network to a second long-haul network;
means for switching between operating as the gateway connecting the short-haul network associated with the facility to the first long-haul network and operating as a node in the short-haul network while another device in the short-haul network serves as a gateway to connect the short-haul network to the second long-haul network;
means for controlling power delivered to the load in response to a load-control message received over the first long-haul network or the second long-haul network and the short-haul network.

18. The reconfigurable load-control receiver of claim 17, wherein the first long-haul network is a network selected from the group consisting of a power line communication network, an internet protocol network, a cellular network and a paging network.

19. The reconfigurable load-control receiver of claim 17, wherein the short-haul network utilizes a communications protocol selected from the group consisting of ZigBee®, ZigBee Smart Energy Profile, Wi-Fi®, Z-Wave®, HomePlug® and Bluetooth®.

20. The reconfigurable load-control receiver of claim 19, wherein the communications protocol is ZigBee.

21. The reconfigurable load-control receiver of claim 20, wherein the means for operating as a gateway includes means for operating as gateway selected from the group consisting of a ZigBee energy services interface, a ZigBee energy services portal, a ZigBee coordinator, and a ZigBee gateway.

22. The reconfigurable load-control receiver of claim 20, wherein the means for operating as a node includes means for operating as a node selected from the group consisting of a ZigBee end device and a ZigBee router.

23. The reconfigurable load-control receiver of claim 17, wherein the other device in the short-haul network that serves as a gateway to connect the short-haul network to the second long-haul network includes a utility meter that serves as a gateway to the second long-haul network as part of an advance metering infrastructure.

24. The reconfigurable load-control receiver of claim 17, further comprising means for translating a load control message received over the first long-haul network according to a first communications protocol to a load control message according to a second communications protocol, and means for transmitting the translated load control message to devices on the short-haul network.

25. A reconfigurable load-control receiver for initial communication with a first long-haul network and selectively adaptable to be reconfigured and in communication with a second long-haul network, a short-haul network associated with a facility that includes the reconfigurable load-control receiver and an electrical load controlled by the reconfigurable load-control receiver, the reconfigurable load-control receiver comprising:
a switching device adapted to control power to an electrical load at a facility; and
a controller communicatively coupled to the switching device and adapted to switch between operating as a gateway connecting a short-haul network associated with a facility to a first long-haul network, and operating as a node in the short-haul network, the controller including:
a long-haul transceiver adapted to receive load-control messages over the first long-haul network;
a short-haul transceiver adapted to receive and transmit messages over a short-haul network associated with the facility; and
a processor communicatively coupled to the long-haul transceiver and the short-haul transceiver, the processor adapted to control the switching device in response to load-control messages received over the first long-haul network while the controller is configured as the gateway and to control the switching device in response to load-control messages received over the short-haul network and a second long-haul network while the controller is configured to operate as a node of the short-haul network.

26. The reconfigurable load-control receiver of claim 25, wherein the switching device is a relay.

27. The reconfigurable load-control receiver of claim 25, wherein the first long-haul network is a network selected from the group consisting of a power line communication network, an interne protocol network, a cellular network and a paging network.

28. The reconfigurable load-control receiver of claim 27, wherein the first long-haul network is a paging network, and the long-haul transceiver is a radio-frequency transceiver.

29. The reconfigurable load-control receiver of claim 25, wherein the short-haul network utilizes a communications protocol selected from the group consisting of ZigBee®, ZigBee Smart Energy Profile, Wi-Fi°, Z-Wave®, HomePlug® and Bluetooth®.

30. The reconfigurable load-control receiver of claim 29, wherein the short-haul network utilizes a ZigBee communications protocol and the short-haul transceiver is a radio-frequency transceiver adapted to comply with the ZigBee communications protocol.
